(19) United States
(12) Patent Application Publication
(10) Pub. No.: US 2002/0023993 A1
(43) Pub. Date: Feb. 28, 2002

(54) Wall mountable accessory assembly

(76) Inventors: Gary A. Fleischmann, Sheboygan, WI (US); Joel T. Smith, Sheboygan, WI (US)

Correspondence Address: QUARLES & BRADY LLP, 411 E. WISCONSIN AVENUE, SUITE 2040, MILWAUKEE, WI, 53202-4497, US

(21) Appl. No.: 09/886,600

(22) Filed: Jun. 21, 2001

Related U.S. Application Data
(60) Provisional application No. 60/212,978, filed on Jun. 21, 2000.

(51) Int. Cl. A47K 10/00; F16L 3/08; F21V 21/00

(52) U.S. Cl. 248/315; 248/222.52; 211/16

(57) ABSTRACT

Disclosed are wall mountable accessories which have a bracket with an axial extension and a plate adjacent an inward end of the extension. An escutcheon shrouds the bracket. A recess and projection connection is provided between the plate and escutcheon that restrict relative rotation there between so that the escutcheon can be properly positioned. An accessory, such as a bathroom accessory, is removably linked to the escutcheon adjacent its outer end.

### CROSS-REFERENCE TO RELATED APPLICATIONS

This application claims benefit to U.S. Provisional Patent Application No. 60/212,978, filed Jun. 21, 2000.

### STATEMENT REGARDING FEDERALLY SPONSORED RESEARCH/DEVELOPMENT

Not applicable.

### BACKGROUND OF THE INVENTION

The present invention relates to bathroom accessories and other wall mountable fittings.

Towel rings, towel bars, robe hooks, soap dish holders, toothbrush holders, toilet paper holders, glass holders, bathroom shelves and other accessories are attached to walls by a variety of known techniques. The simplest systems rely on exposed screws or bolts that screw into the supporting structure, or screw into structures positioned thereon.

However, it is desirable to hide the means of connection to the wall. Some systems which do this exist, but do not provide a sufficiently secure connection, or rely on a complex and expensive assembly of parts. Other systems, such as that depicted in FIG. 5 of U.S. Pat. No. 4,349,940, use a bracket that is mounted to a wall with screws to provide a secure connection. An integral tubular extension projects outward from the plate into a bore of a decorative escutcheon. An axial screw attaches the escutcheon to the tubular extension. The accessory is then connected to the escutcheon via a transverse connection. While this assembly is useful for certain applications, it constrains the aesthetic appearance that the final accessory can have.

In still other known accessories a bracket is mounted to a wall and a set screw is provided that projects inward from the accessory itself against the bracket. These accessories often have a connection which loosens over time. Also, the optimal alignment of the set screw is sometimes difficult to achieve.

Apart from the deficiencies in existing prior art systems, there is sometimes a desire to replace certain accessories on a temporary basis. For example, for a themed party it may be desirable to have fittings of one color, decoration or type, and then change back to the every day fittings after the party. Also, for certain events it may be desirable to have fewer towel bars and more clothing hooks, while for other the opposite may be true. Existing wall mountable accessories are often difficult to replace on a temporary basis without leaving visible damage to the wall.

It can therefore be seen that a need exists for improved wall mountable accessory systems.

### SUMMARY OF THE INVENTION

In accordance with a first aspect of the invention, a wall mountable accessory assembly is provided. It has a bracket with an axial extension and a plate adjacent an inward end of the extension. There is an elongated escutcheon having an axial through bore that receives the axial extension.

A recess and projection connection is provided between the plate and escutcheon that restricts relative rotation there between, the connection being activated by relative axial movement there between. An accessory is linked to the escutcheon adjacent an outer end of the escutcheon.

In preferred forms the through bore is configured so as to receive a shaft of the accessory, and there is a screw extending radially through the escutcheon against the shaft to retain the shaft in the through bore. There can also be a flange that is positioned in the through bore at the narrowed portion and a bolt inserted axially through the narrowed portion such that an inward end of the bolt is in the bracket extension and a head of the bolt is prevented from passing inward all the way through the escutcheon by the flange.

Preferably the projection is a lug formed on the plate extending outward from the plate, and the recess is a socket formed on an inwardly directed surface of the escutcheon. If desired, the plate can have two through holes, at least one of which is arcuate, to facilitate alignment of the escutcheon.

These as well as other features and advantages of the present invention will be apparent from the description which follows. In the detailed description below preferred embodiments of the invention will be described with reference to the accompanying drawings. These embodiments do not represent the full scope of the invention. Rather the invention may be employed in other embodiments, and reference should therefore be made to the claims herein for interpreting the breadth of the invention.

### BRIEF DESCRIPTION OF THE DRAWINGS

FIG. 1 is a right, upper, frontal perspective view of a towel ring, in accordance with the present invention;

FIG. 2 is an exploded view of the assembly of FIG. 1;

FIG. 3 is a sectional view taken along line 3-3 of FIG. 1;

FIG. 4 is a view similar to FIG. 3, but showing a second radial position of the bracket relative to the escutcheon;

FIG. 5 is a sectional view taken along line 5-5 of FIG. 3; and

FIG. 6 is a fragmentary section taken along line 6-6 of FIG. 5.

### DETAILED DESCRIPTION OF THE INVENTION

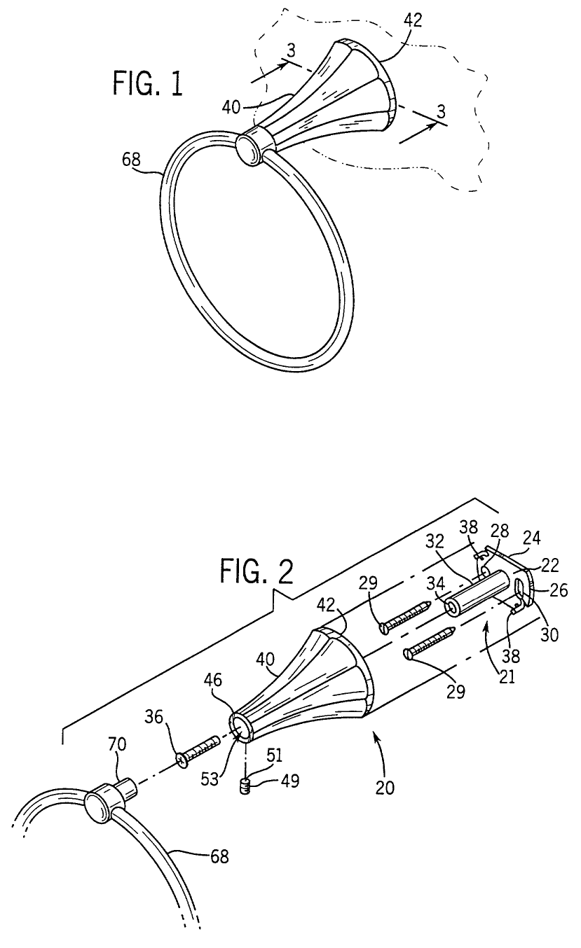

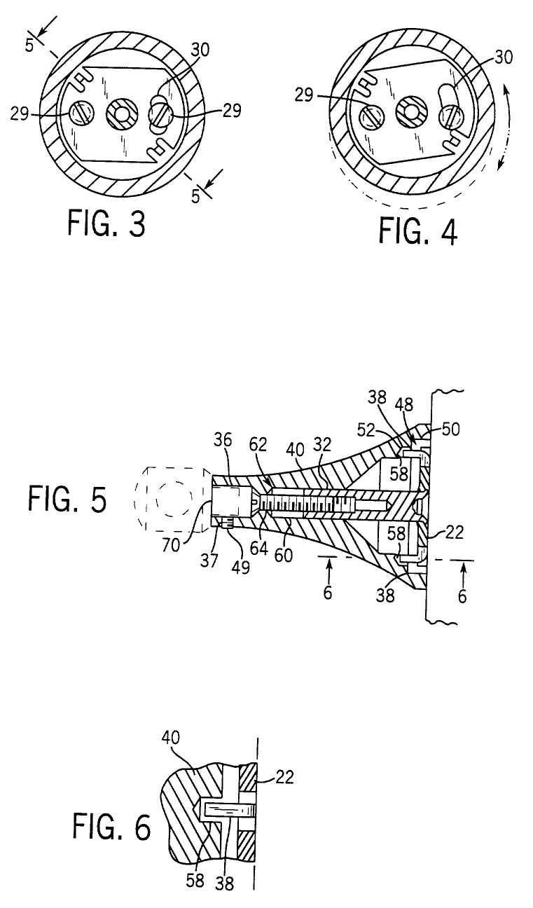

Referring initially to FIGS. 1 and 2, a towel bar 20 includes a wall bracket 21 having a generally flat mounting plate 22 with oppositely disposed straight walls 24 that are connected by rounded walls 26. The mounting plate 22 has a circular aperture 28 and a kidney shaped aperture 30, both of which are configured to receive a screw 29 therein. The screw is inserted through the holes and screwed into a wall support.

Typically the wall is a vertical room wall (e.g. a bathroom wall). However, the walls could be a horizontal wall of an island installation, or a vertical or horizontal walls of some other structure.

It will be appreciated that the kidney shaped aperture 30 allows rotation of the plate 22 about the circular aperture 28 so as to provide some room for rotational adjustment when mounting the plate 22 to the wall. The wall bracket 20 further includes an axially disposed elongated cylindrical stem/extension 32 extending outwardly therefrom. It has a threaded internal bolt hole 34 configured to receive a bolt fastener 36 therein. A pair of oppositely disposed generally rectangular position pins/lugs 38 extend generally perpendicularly outwardly from the plate 22. These may be integral with the plate, or may be attached thereto.

An axially extending decorative escutcheon 40 has a base 42 and an elongated body 44 that tapers outwardly to tip 46. There is an opening 53 that is configured to accept a mounting shaft 70 of an accessory such as a towel ring 68. Alternatively, the shaft could be a support bar for a towel bar, an extension from a robe hook, or any other type of shaft extension linked to an accessory.

A radially extending aperture 37 is formed within an outer wall of the tip 46. It receives a radially extending set screw 49 that has a tip 51.

As shown in FIG. 5 the escutcheon 40 includes a through bore 48. The bore can completely shroud the entire mounting plate 22 therein. As a result, when the wall bracket 21 is secured to the escutcheon 40, only the escutcheon will be visible to a user.

An annular seat 52 presents an outer surface 54 that engages the periphery of the mounting plate when the escutcheon is mounted onto the mounting plate. It is disposed within the inner chamber 48 and includes a pair of notches 58 extending axially therein and of a length slightly greater than the length of the position pins 38. The through bore 48 tapers into a generally cylindrical inner bore 60 having a sufficient diameter so as to still be able to receive the stem 32. A radially extending flange 62 is disposed within the bore 60 so as to provide a seat 64 at a further narrowing of the bore. Bolt 36 is inserted into the bore and fastened to the stem 32 to fix the wall bracket 21 to the escutcheon 40.

Once the mounting plate 22 has been fastened to the wall using the two screws 29, and preliminarily positionally adjusted, the escutcheon 40 is mounted over the wall bracket 21, thereby inserting the positioning pins 38 into the sockets 58. It will be appreciated that this restricts relative rotation of the escutcheon with respect to the wall bracket 21, and correspondingly with respect to the wall. Preferably, the mounting plate 22 is radially orientated such that the set screw 49 is pointed precisely downwardly when the escutcheon 40 is mounted onto the wall bracket 21 (so as to reduce the visibility of the set screw). Should the set screw end up slightly off the exact downward direction, the plate can be rotated slightly with respect to the escutcheon to correct this (by loosening the screw 29 through the kidney shaped hole, rotating the plate, and then retightening the screw).

In an alternative embodiment the positioning pins or other projections could be disposed on the escutcheon 40 and configured to be received by corresponding recesses that are disposed within a surface of the wall bracket 21.

Towel ring 68 includes a mounting shaft stub 70 having an outer diameter that is smaller than the inner diameter of the sleeve opening 53. Accordingly, the towel ring 68 is mounted into assembly 20 by inserting the mounting shaft 70 into the axially disposed sleeve opening 53 so that the mounting fixture extends perpendicular with respect to the wall. The set screw 47 is then rotated until the tapered end 51 impinges against the mounting shaft 70, thereby retaining the towel ring 68 in place.

A different accessory can easily replace the towel ring simply by untightening the set screw, removing the towel ring, inserting a stub from another accessory (e.g. a prong from a towel bar), and then retightening the set screw. No damage to the wall need occur or be exposed and the replacement can take place quickly using only a conventional screw driver.

Instead of using a set screw, one might (in an alternate embodiment) provide the inner walls of the escutcheon tip 46 and the stub 70 of the accessory with mateable threads so that the parts can be threaded together. This avoids any need for a special tool to secure the connection or permit the replacement. However, that assembly is somewhat more susceptible to vandalism.

The invention has been described in connection with what are presently considered to be the preferred embodiments. However, these embodiments have been presented by way of illustration. Accordingly, those skilled in the art will realize that the invention is intended to encompass all modifications and alternative arrangements included within the spirit and the scope of the invention, as set forth by the appended claims.

### INDUSTRIAL APPLICABILITY

Disclosed are assemblies for mounting accessories such as bathroom accessories on walls.

What is claimed is:

1. A wall mountable accessory assembly, comprising:
a bracket having an axial extension and a plate adjacent an inward end of the extension;
an elongated escutcheon having an axial through bore, the through bore receiving the axial extension;
a recess and projection connection between the plate and escutcheon that restricts relative rotation there between, the connection being activated by relative axial movement there between; and
an accessory linked to the escutcheon adjacent an outer end of the escutcheon.

2. The assembly of claim 1, wherein the through bore is configured so as to receive a shaft of the accessory, and there is a screw extending radially through the escutcheon against the shaft to retain the shaft in the through bore.

3. The assembly of claim 1, wherein a flange is positioned in the through bore at a narrowed portion of the bore, and a bolt is axially inserted through the narrowed portion such that an inward end of the bolt is in the bracket extension and a head of the bolt is prevented from passing inward all the way through the escutcheon by the flange.

4. The assembly of claim 1, wherein the projection is a lug formed on the plate extending outward from the plate, and the recess is a socket formed on an inwardly directed surface of the escutcheon.

5. The assembly of claim 4, wherein the plate has two through holes, at least one of which is arcuate.
